(19) United States
(12) Patent Application Publication
(10) Pub. No.: US 2025/0379431 A1
(43) Pub. Date: Dec. 11, 2025

(54) AN ASSEMBLY OF A HOLDER DEVICE AND AN ELECTRONIC MODULE

(71) Applicant: SIGNIFY HOLDING B.V., EINDHOVEN (NL)

(72) Inventors: PETER JOHANNES MARTINUS BUKKEMS, Deurne (NL); OLIVER FRANCIS BURKE, EINDHOVEN (NL); MICHAL JAN HORACZEK, BEST (NL); DERK TIEKINK, MIERLO (NL); GEORGES MARIE CALON, EINDHOVEN (NL)

(21) Appl. No.: 18/875,642

(22) PCT Filed: Jun. 20, 2023
(86) PCT No.: PCT/EP2023/066683

§ 371 Date: Dec. 16, 2024

(30) Foreign Application Priority Data
Jun. 23, 2022 (EP) 22180736.5

(51) Int. Cl. H02G 3/03

(52) U.S. Cl. CPC H02G 3/03

(57) ABSTRACT

The invention provides an assembly of a holder device and an electronic module, wherein the holder device comprises an outer surface and a Zhaga slot; wherein the Zhaga slot is recessed in said outer surface and is configured to mechanically connect the electronic module to the holder device; wherein the electronic module comprises: a main body comprising an electronics compartment; an electronic component arranged in said electronics compartment; a rim arranged in thermal communication with the electronic component and/or the electronics compartment; wherein the rim is configured to abut the outer surface of the holder device when the electronic module is mechanically connected to the holder device; wherein the rim is configured to transfer heat from the electronic component and/or electronics compartment into the ambient; wherein the rim extends beyond the standardized boundaries demarcated for a Zhaga module suitable for the Zhaga slot.

### FIELD OF THE INVENTION

The invention relates to an assembly of a holder device and an electronic module, wherein the holder device comprises a Zhaga slot for mechanically connecting the electronic module to the holder device. The invention relates to the holder device being for example a luminaire.

### BACKGROUND OF THE INVENTION

The built environment is more and more equipped with add-on modules providing functionalities such as sensing, communication, and/or actuation. Such modules may for example be connected to a luminaire, as the lighting infrastructure typically provides a structured grid of locations with access to power and/or a data backbone.

Therefore, to facilitate the adoption of such modules, the lighting industry has established standards for modules being used for sensing and/or communication. One of such standards is the Zhaga Standard. Zhaga Book 20, in particular, defines a smart interface between an indoor LED luminaire and a module for sensing and/or communication.

The mechanical interface defined in the Zhaga Book 20 standard is a dedicated Zhaga slot-having certain standardized dimensions-into which an add-on module may be mounted. Thereby, such a module may be Zhaga compliant as well (i.e. be a Zhaga module), if said module fulfills certain dimensions and demarcated boundaries relative to the Zhaga slot.

A problem of said Zhaga slot (i.e. as defined in said Zhaga Book 20) and/or a corresponding Zhaga module (i.e. Zhaga compliant add-on module suitable for said Zhaga slot) is that their respective dimensions are limited to the Zhaga standard. Consequently, the limited dimensions of the slot also limit the thermal dissipation of an add-on module mounted in said slot. This also limits the maximum power of an add-on module.

While on the one hand the maximum power of an add-on module is limited due to the limited dimensions of the Zhaga slot, there is a clear need on the other hand to introduce new functionalities to such add-on modules enabling higher power applications, such as for example UVC disinfection, Li-Fi communication, and/or UVB therapy.

Hence, there is a clear need to introduce new functionalities to add-on modules for the Zhaga slot, while ensuring their thermal performance remains sufficient to remove generated heat.

### SUMMARY OF THE INVENTION

It is an object of the invention to provide an improved assembly of a holder device comprising a Zhaga slot and an electronic module, which at least alleviates the problems and disadvantages mentioned above. Thereto, the invention provides, an assembly of a holder device and an electronic module, wherein the holder device comprises an outer surface and a Zhaga slot; wherein the Zhaga slot is recessed in said outer surface and is configured to mechanically connect the electronic module to the holder device; wherein the electronic module comprises: a main body comprising an electronics compartment; an electronic component arranged in said electronics compartment; a rim arranged in thermal communication with the electronic component and/or the electronics compartment; wherein the rim is configured to abut the outer surface of the holder device when the electronic module is mechanically connected to the holder device; wherein the rim is configured to transfer heat from the electronic component and/or electronics compartment into the ambient; wherein the rim extends beyond the standardized boundaries demarcated for a Zhaga module suitable for the Zhaga slot.

Hence, in the proposed assembly, the electronic module is configured to be mechanically connected to the recessed Zhaga slot on the surface of the holder device. The rim of the electronic module is furthermore transferring the heat from the electronic component and/or the electronics compartment into the ambient. This renders an improved heat dissipation, and consequently enables more (higher power) functionalities, for the electronic module that is mounted in the Zhaga slot. However, because the rim extends beyond the standardized boundaries demarcated for a Zhaga module suitable for the Zhaga slot, the electronic module is no longer Zhaga compliant. Therefore, the present invention advantageously renders the possibility of introducing new (higher power or thermally sound) functionalities to the electronic module by making the electronic module not (or: no longer) Zhaga compliant (with the introduction of said rim), but still Zhaga connectable (to the Zhaga slot). Said Zhaga slot may alternatively be phrased as Zhaga Book 20 slot, or Zhaga F1 luminaire slot.

It may be intuitive to utilize most of the volumetric space of an electronic module for electronics, especially if said electronic module comprises a relatively small form-factor, and because the very purpose of an electronics module is to provide electronics enabling a desired function. However, if such an electronic module is mounted and/or assembled in a Zhaga slot, the amount of heat that can be removed by the Zhaga slot itself may be limited. It may also be undesired or cumbersome to modify the holder device, for example adding a heat sink to the holder device comprising the Zhaga slot.

Therefore, in an embodiment of the present invention, the volume of the electronics compartment may be at least a factor three smaller than the volume of the Zhaga slot. In aspects, the volume of electronics compartment may be at least a factor four smaller than the volume of the Zhaga slot, such as a factor five.

Such an embodiment may be advantageous, because the volume of the electronics compartment of the electronic module is limited relative to the volume of the Zhaga slot into which the electronic module is mounted in assembly, thereby leaving room in the electronic module and/or the Zhaga slot itself to provide a thermal dissipation function.

For example, in a related embodiment, the main body may comprise a heat sink structure configured to transfer heat from the electronic component and/or the electronics compartment to the ambient; wherein the heat sink structure is at least partly arranged outside the electronics compartment and within the volume of the Zhaga slot.

In an embodiment, the heat sink structure comprises a heat sink and a heat conducting rod; wherein the heat sink is arranged outside the electronics compartment; wherein the heat conducting rod extends into the electronics compartment and connects the electronic component to the heat sink.

Hence, the heat sink structure may provide additional cooling to the electronic module, as the volume of the Zhaga slot is made available, by the limited volume of the electronics compartment. The heat sink structure may either be arranged inside the main body of the electronic module, and/or may be arranged outside the main body and in the Zhaga slot of the holder device. In aspects, said heat sink structure may alternatively comprise an active cooling means.

In an embodiment, the electronic module may comprise an optical window arranged on the body; wherein the optical window encloses at least part of the electronics compartment; wherein the optical window enables an optical path between the electronic component and a space exterior to the holding device; wherein the optical window is monolithic with said rim. In aspects, at least part of the optical window may be monolithic with said rim.

Such an embodiment may be advantageous, as the rim and optical window are monolithic, and thereby enable an improved heat transfer from the electronics compartment into the ambient. The optical window also enables the electronic compartment to be in optical communication with the exterior of the holding device, for example a room, office or similar interior space.

In an embodiment, the holder device is a luminaire. In an embodiment, the electronic component comprises at least one sensor. In an embodiment, the electronic component comprises at least one wireless communication module. For example, said wireless communication module may be a Li-Fi module or mmWave module. Such modules may generate a significant amount of heat. Hence, in an embodiment, electronic component comprises a Li-Fi transceiver. Hence, in an embodiment, the electronic component comprises a mmWave radiofrequency transceiver. Said mmWave radiofrequency transceiver may for example be a 5G transceiver.

In an embodiment, the electronic component comprises at least one semiconductor light source. For example, said semiconductor light source may be a LED light source. In an embodiment, the at least one semiconductor light source may be configured to provide ultraviolet light having at least one dominant peak in a wavelength range from 280 to 315 nm (UVB). Such an embodiment may be advantageous, as the electronic module may provide a functionality coupled to the emittance of UVB light, such as vitamin D therapy. Hence, the electronic module may be a vitamin D therapy add-on module to a holder device (such as a luminaire, which luminaire may for example otherwise only emit visible light). In an embodiment, the at least one semiconductor light source may be configured to provide ultraviolet light having at least one dominant peak in a wavelength range from 100 to 280 nm (UVC). Such an embodiment may be advantageous, as the electronic module may provide a functionality coupled to the emittance of UVC light, such as UVC disinfection (e.g. viricidal disinfection). Hence, the electronic module may be a disinfection add-on module to a holder device (such as a luminaire, which luminaire may for example otherwise only emit visible light).

In an embodiment, the electronic component may generate, in operation, at least 1.5 watt of thermal energy.

In an embodiment, the main body may comprise a heat conductive structure; wherein the heat conductive structure is configured to connect the rim to the electronic component and/or the electronics compartment; wherein at least part of the heat conductive structure is aligned along an exterior contour of the main body.

In an embodiment, the main body comprises a housing, wherein said housing is made of a polymer material, wherein the rim is at least partly made of a metal material.

In an embodiment, the electronic module may comprise a connector extending from the main body; wherein the connector is configured to configured to convey power from the holder device to the electronic component, and/or wherein the connector is configured to communicate data between the electronic module and the holder device.

In an embodiment, the luminaire may comprise a light engine and a controller; wherein the controller is configured to receive a data signal from the electronic component of the electronic module; wherein the controller is configured to control the light engine to provide illumination based on said data signal.

In an embodiment, the luminaire may comprise a light engine and a controller; wherein the controller is configured to transmit a control signal from the controller to the electronic component of the electronic module, wherein the control signal is configured to control a property of the electronic component.

In an embodiment, the main body of the electronic module may comprise Zhaga compliant dimensions for a Zhaga module suitable for the Zhaga slot.

In an embodiment, the electronic component may be a sensor bundle comprising a plurality of different sensors.

### BRIEF DESCRIPTION OF THE DRAWINGS

The invention will now be further elucidated by means of the schematic non-limiting drawings:

FIG. 1 depicts schematically an embodiment of an assembly according to the invention;

FIG. 2 depicts schematically an embodiment of an assembly according to the invention;

FIG. 3 depicts schematically, by non-limiting example, a perspective view of an electronic module according to the invention;

FIG. 4 depicts schematically an embodiment of an electronic module according to the invention, wherein the optical window is monolithic with said rim.

### DETAILED DESCRIPTION OF THE EMBODIMENTS

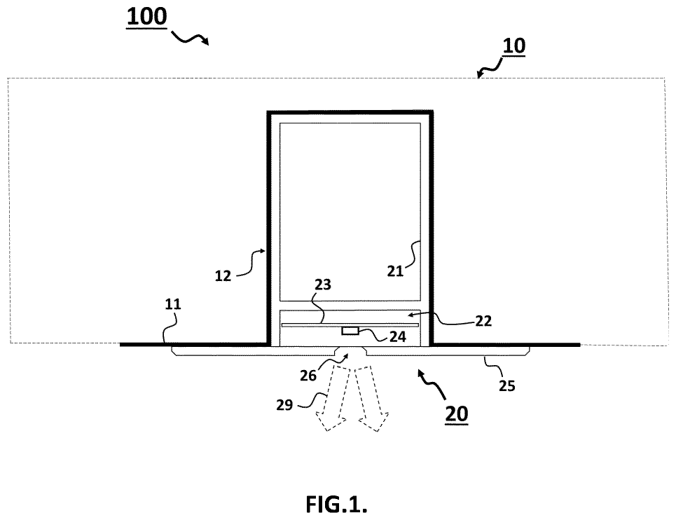

FIG. 1 depicts schematically, by non-limiting example, an embodiment of an assembly 100 according to the invention. FIG. 1 depicts a cross-sectional sideview. The assembly 100 comprises a holder device 10 and an electronic module 20. Here, the holder device 10 is a luminaire. The luminaire 10 is only partly depicted in the cross-sectional sideview of FIG. 1. The holder device may alternatively be for example a sensor housing, or a recessed ceiling element, or a surface tile.

The luminaire 10 comprises an outer surface 11 and a Zhaga slot 12. The Zhaga slot 12 is recessed in said outer surface 11. The Zhaga slot 12 complies with the corresponding Zhaga standard, such as for example the Zhaga Book 20 standard. Therefore, the dimensions of the Zhaga slot 12 are known and fixed. The Zhaga slot 12 is configured to mechanically connect (or alternatively phrased: to fit) a module to the luminaire 10. Such a module will also be Zhaga compliant if the dimensions of such a module are within the standardized boundaries demarcated for a Zhaga module suitable for the Zhaga slot.

The electronic module 20 according to the invention is mechanically connectable to the luminaire 10 (i.e. the holder device). The electronic module 20 comprises a main body 21. The electronic module 20 is connectable to the Zhaga slot 12 via the main body 21. Hence, the dimensions of the main body 21 enable the electronic module 20 to be mechanically connected (or: fitted) to the Zhaga slot 12.

The main body 21 comprises an electronics compartment 22. The electronic module 20 further comprises an electronic component 23. The electronic component 23 is thereby arranged in said electronics compartment 22 of the main body 21.

In the present embodiment, the electronic component 23 is a PCB that comprises at least one semiconductor light source 24, namely an ultraviolet LED 24.

Alternatively, said electronic component may comprise a wireless communication module. Such wireless communication module may generate, in operation, at least 1.5 watt of thermal energy. For example, the electronic component may be a radiofrequency receiver, transmitter, or transceiver, such as for example a mmWave radiofrequency transceiver, e.g. a 5G antenna. Alternatively, said electronic component may be a Li-Fi transmitter, Li-Fi receiver, or Li-Fi transceiver. Yet alternatively, said electronic component may comprise at least one sensor, or may comprise a sensor bundle. Such at least one sensor may be an active sensor, such as a microwave sensor, a radar sensor, an infrared sensor. Said sensor may alternatively be a PIR sensor.

Referring to FIG. 1, the ultraviolet LED 24 is configured to provide ultraviolet light, in operation, which ultraviolet light has at least one dominant peak in the wavelength range from 280-315 nm (i.e. UV-B range). The electronic module 20 is therefore configured to provide UV-B light 29. As commonly known, such UV-B light may be utilized to provide vitamin D generating light therapy. The electronic module 20 may therefore be considered as an add-on module to the luminaire 10, wherein the module is rendering a vitamin D generating light therapy, while the luminaire 10 itself may for example only comprise a visible light source arranged to emit visible light in operation. Hence, the ultraviolet LED may be configured to emit UV-B light comprising a light intensity configured to generate vitamin D to a human receiving said UV-B light.

Additionally or alternatively, the ultraviolet LED may be configured to provide ultraviolet light, in operation, which ultraviolet light has at least one dominant peak in the wavelength range from 100-280 nm (i.e. UVC range). The electronic module may therefore be configured to provide UV-C light in operation. As commonly known, such UVC light may be utilized for (viricidal or bacterial) disinfection. The electronic module may therefore be considered as an add-on module to the luminaire, wherein the module is rendering disinfection, while the luminaire 10 itself may for example only comprise a visible light source arranged to emit visible light in operation.

In operation, said ultraviolet LED 24 generates an amount of heat. If said heat cannot be fully dissipated by the fixed dimensions of the Zhaga slot 12 (i.e. e.g. by the respective surface areas dissipating the heat), the heat may render an undesirably high junction temperature in the ultraviolet LED 24. High junction temperatures in the ultraviolet LED 24 may for example lead to a limited efficiency, shorter lifetime, and poor operation. For example, for an UV-B LED, a junction temperature above 60 degrees Celsius may already become critical.

Hence, due to the standardized and fixed dimensions of the Zhaga slot 12, the Zhaga slot 12 can only dissipate a certain amount of heat originating from the electronic module 20.

Still referring to FIG. 1, the electronic component 23 that is arranged in the electronics compartment 22 of the main body 21 of the electronic module 20 may generate heat due to the presence of the ultraviolet LED 24. This heat needs to be removed to enable the functionality of providing UVB light (and corresponding light therapy). However, as partly mentioned, the Zhaga slot 12 may be insufficient in its dimensions to remove said heat. In examples, the electronic component 23 may for example generate at least 1.5 watt of thermal energy.

Therefore, the electronic module 20 further comprises a rim 25. Here, the rim is in thermal communication with the electronics compartment accommodating the electronic component 23. Said thermal communication is at least partly conductive. Alternatively, the rim may be in thermal communication with the electronic component, such as with the PCB. The rim 25 is thereby abutting the outer surface 11 of the luminaire 10 (i.e. the holder device) when the electronic module 20 is mechanically connected to the luminaire 10. The rim 25 thereby transfers heat from the electronics compartment 22 (or the electronic component 23) into the ambient. The ambient being either a body of the luminaire 10 and/or the atmosphere surrounding the luminaire 10.

More specifically, in the present embodiment, albeit optionally, the electronic module 20 comprises an optical window 26 arranged on the main body 21. The optical window 26 is thereby enclosing at least part of the electronics compartment 22, in which the ultraviolet LED 24 is arranged. The optical window 26 is transparent to ultraviolet light, thereby enabling an optical path between the electronic component 23 and a space exterior to the luminaire 10 (i.e. the holding device). Alternatively, said optical window may be translucent to ultraviolet light. Here, by non-limiting example, the optical window 26 is monolithic with said rim 25. This enables an improved dissipation of heat.

The rim 25 may for example be made of a ceramic material. Said rim 25 may alternatively be made at least partly by a metal material. Thereby, the main body 21 may be made of a polymer material.

Still referring to FIG. 1, the rim 25 extends beyond the standardized boundaries demarcated for a Zhaga module suitable for the Zhaga slot 12. Hence, the electronic module 20 is not Zhaga compliant, and only Zhaga connectable. However, even though the electronic module 20 is not (or: no longer) Zhaga compliant due to the extending rim 25, the electronic module 20 is still being able to mechanically connect to the luminaire and provide additional (high-power) functionalities, such as providing UV-B light, that were otherwise not possible without such a rim 25.

All in all, the present invention advantageously renders the possibility of introducing new (higher power or thermally sound) functionalities to the electronic module 20, namely for example UVB illumination and/or vitamin D light generating therapy, by making the electronic module 20 not (or: no longer) Zhaga compliant (with the introduction of said rim 25), but still Zhaga connectable (to the Zhaga slot 12).

The optical window 26 may further comprise, in certain embodiments, a solid part and an aperture part (or: opening part) in said solid part. Said solid part may thereby be monolithic with said rim 25. Alternatively, said solid part may be abutting said rim, or be mechanically and thermally connected to said rim according to known manufacturing processes, said mechanical connection and thermal connection enabling conductive heat transfer between the solid part and the rim.

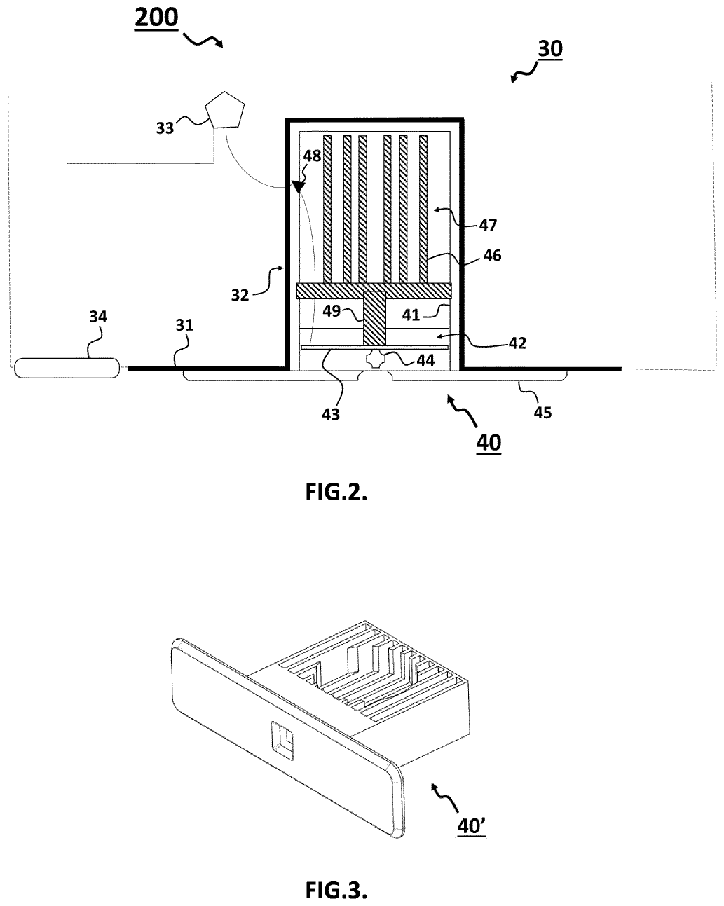

FIG. 2 depicts schematically, by non-limiting example, an embodiment of an assembly 200 according to the invention. FIG. 2 depicts a cross-sectional sideview. The assembly 200 comprises a holder device 30 and an electronic module 40. Here, the holder device 30 is a luminaire. The luminaire 30 is only partly depicted in the cross-sectional sideview of FIG. 1. The holder device may alternatively be a sensor housing, or a recessed ceiling element, or a surface tile.

The luminaire 30 comprises an outer surface 31 and a Zhaga slot 32. The Zhaga slot 32 is recessed in said outer surface 31. The Zhaga slot 32 complies with the corresponding Zhaga standard, such as for example the Zhaga Book 20 standard. Therefore, the dimensions of the Zhaga slot 32 are known and fixed. The Zhaga slot 32 is configured to mechanically connect (or alternatively phrased: to fit) a module to the luminaire 30. Such a module will also be Zhaga compliant if the dimensions of such a module are within the standardized boundaries demarcated for a Zhaga module suitable for the Zhaga slot.

The luminaire 30 further comprises, albeit optionally, by non-limiting example, a controller 33 and a light engine 34. The light engine 34 comprises a visible light source, and is configured to emit visible light in operation. Said light engine 34 may alternatively be phrased as a light module, or as a light unit. The controller 33 is configured to control the light engine 34.

The electronic module 40 according to the invention is mechanically connectable to the luminaire 30 (i.e. the holder device). More specifically, the electronic module 40 comprises a main body 41. The electronic module 40 is connectable to the Zhaga slot 32 via the main body 41. Hence, the dimensions of the main body 41 enable the electronic module 40 to be mechanically connected (or: fitted) to the Zhaga slot 32.

Here, the electronic module 40 is also electrically connectable to the luminaire (i.e. the holder device). More specifically, the electronic module 40 comprises a connector 48. The connector 48 may either be (integral) part of the main body 41, and/or may extend from the main body 41. For example, said connector 48 may be a cable with a plug, or cable with a socket.

The main body 41 comprises an electronics compartment 42. The electronic module 40 further comprises an electronic component 43. The electronic component 43 is thereby arranged in said electronics compartment 42 of the main body 41.

The connector 48 is configured to convey power from the luminaire 30 (i.e. the holder device) to the electronic component 43; and/or the connector 48 is configured to communicate data between the electronic module 40 and the luminaire 30 (i.e. the holder device). Moreover, said controller 31 of the luminaire 30 may be configured to receive a data signal from the electronic component 43 of the electronic module 40. The controller 33 may then control the light engine 34 to provide (visible) illumination based on said data signal.

Alternatively, the controller may be configured to transmit a control signal from the controller to the electronic component of the electronic module, wherein the control signal is configured to control a property of the electronic component.

Still referring to FIG. 2, in the present embodiment, the electronic component 43 is a wireless communication module. Said wireless communication module 43 comprises a Li-Fi transceiver 44. The Li-Fi transceiver 44 is configured to communicate with a corresponding communication device in the space exterior to the luminaire 30.

Alternatively, said electronic component may comprise a radiofrequency receiver, transmitter, or transceiver, such as for example a mmWave radiofrequency transceiver, e.g. a 5G antenna. Yet alternatively, said electronic component may comprise at least one semiconductor light source. Yet alternatively, said electronic component may comprise at least one sensor, such as e.g. a microwave sensor or radar sensor.

In operation, said Li-Fi transceiver 44 generates an amount of heat. If said heat cannot be fully dissipated by the fixed dimensions of the Zhaga slot 32 (i.e. e.g. by the respective surface areas dissipating the heat), the heat may render an undesirably high temperatures at said wireless communication module 43, 44.

Hence, due to the standardized and fixed dimensions of the Zhaga slot 32, the Zhaga slot 32 can only dissipate a certain amount of heat originating from the electronic module 40.

Still referring to FIG. 2, the electronic component 43 that is arranged in the electronics compartment 42 of the main body 41 of the electronic module 40 may generate heat. This heat needs to be removed to enable the functionality of Li-Fi communication. However, as partly mentioned, the Zhaga slot 32 may be insufficient in its dimensions to remove said heat. In examples, the electronic component 43 may for example generate at least 1.5 watt of thermal energy.

Therefore, the electronic module 40 further comprises a rim 45. Here, the rim is in thermal communication with the electronics compartment 42 accommodating the electronic component 43. Said thermal communication is at least partly conductive. Alternatively, the rim may be in thermal communication with the electronic component, such as with the wireless communication module 43 (or the Li-Fi transceiver) itself.

The rim 45 is thereby abutting the outer surface 31 of the luminaire 50 (i.e. the holder device) when the electronic module 40 is mechanically connected to the luminaire 50. The rim 45 thereby transfers heat from the electronics compartment 42 (or the electronic component 43) into the ambient. The ambient being either a body of the luminaire 30 and/or the atmosphere surrounding the luminaire 30.

Here, the rim 45 also extends beyond the standardized boundaries demarcated for a Zhaga module suitable for the Zhaga slot 32. Hence, the electronic module 40 is not Zhaga compliant, and only Zhaga connectable. However, even though the electronic module is not (or: no longer) Zhaga compliant due to the extending rim 45, the electronic module is still being able to mechanically connect to the luminaire 30 and provide additional (high-power) functionalities, such as providing Li-Fi communication, that were otherwise not possible without such a rim 45.

All in all, the present invention advantageously renders the possibility of introducing new (higher power or thermally sound) functionalities to the electronic module 40, namely for example Li-Fi communication, by making the electronic module 40 not (or: no longer) Zhaga compliant (with the introduction of said rim 45), but still Zhaga connectable (to the Zhaga slot 42).

The thermal performance may be improved even further in combination with said rim 45. Namely, as partly mentioned before, it may be intuitive to utilize most of the volumetric space of an add-on module for electronics, such as the embodied Li-Fi transceiver. However, as the present electronic module 40 is mounted and/or assembled in said Zhaga slot 32, the amount of heat that can be removed by the Zhaga slot 32 itself may be limited. It may also be undesired or cumbersome to modify the luminaire 30 itself, for example adding a heat sink to the luminaire 30. Hence, it may be advantageous to limit the volume of the electronics compartment 42.

Hence, still referring to FIG. 2, the volume of the electronics compartment 42 is at least a factor four smaller than the volume of the Zhaga slot 32.

Such an embodiment may be advantageous, because the volume of the electronics compartment 42 of the electronic module 40 is limited relative to the volume of the Zhaga slot 32 into which the electronic module 40 is mounted in assembly, thereby leaving room in the electronic module 40 (and/or the Zhaga slot 32 itself) to provide a thermal dissipation function.

More specifically, the main body 41 may comprise a heat sink structure 47 configured to transfer heat from the electronic component 43 and/or the electronics compartment 42 to the ambient. The heat sink structure 47 is at least partly arranged outside the electronics compartment 42 and within the volume of the Zhaga slot 32.

The heat sink structure 47 comprises a heat sink 46 and a heat conducting rod 49. The heat sink 46 is arranged outside the electronics compartment 42. The heat conducting rod 49 extends into the electronics compartment 42 and connects the electronic component 43 to the heat sink 46. Hence, the heat sink structure 47 may provide additional cooling to the electronic module 40. In embodiments, the heat sink structure 47 may abut the main body 41, or at least one wall of the main body 41 to be more specific, thereby also enabling conductive heat transfer through (the walls of) the main body 41, for example at least partly towards the rim 45 to get the heat dissipated in the ambient exterior to the luminaire as well.

FIG. 3 depicts schematically, by non-limiting example, a perspective view of an electronic module of the embodiment depicted in FIG. 2, but with an UV-B light source instead of a Li-Fi transceiver.

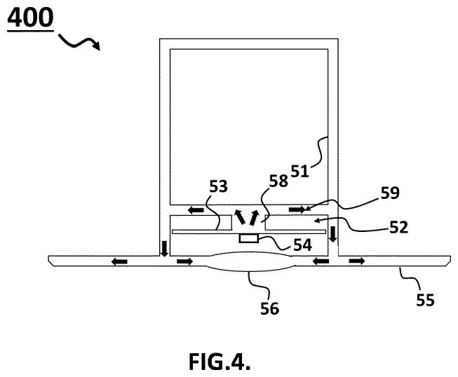

FIG. 4 depicts schematically, by non-limiting example, a sideview of an electronic module 400 according to the invention. Said electronic module 400 may be fit (or: mechanically connected) into a Zhaga slot recessed in an outer surface of a holder device according to the invention. The electronic module 400 comprises a main body 51. The main body 51 comprises an electronics compartment 52. The electronic compartment 52 comprises an electronic component 53. Here, the electronic component 53 is a carrier comprising a mm Wave transceiver 54, or is the mmWave transceiver 54 itself. Said mmWave transceiver may alternatively be for example an ultraviolet LED light source. Said electronic component 53 generates heat. The main body 51 further comprises a rim 55. Here, the rim 55 and at least part of the remainder of the main body 51 are monolithic. The rim 55 is arranged in thermal communication with the electronic component 53, 54 and the electronics compartment 52. The rim 55 extends beyond the standardized boundaries demarcated for a Zhaga module suitable for the Zhaga slot. More specifically, the heat generated by the electronic component 53, 54, and the resulting heat of the electronics compartment 52, will be transferred via the main body 51 to the rim 55. Said heat may be transferred via mechanical structures 58 of the main body 51, or via walls of the main body 51. For example, the heat generated by the electronic component 53, 54, and the resulting heat of the electronics compartment 52 will at least partly be transferred via a connecting structure 58 connecting the electronic component 53, 54 and the main body 51. The rim 55 is exposed to the ambient, either to the atmosphere or abutting the outer surface of the luminaire as mentioned, when fitted into said Zhaga slot of the holder device. Hence, a clear conductive heat path 59 is established to dissipate the generated heat. Such configuration and heat

Still referring to FIG. 4, the main body 51 comprises an optical window 56 to allow the mmWave radio signals to pass. Here, the optical window 56 encloses at least part of the electronics compartment, and enables a radio path between the electronic component and a space exterior to the holding device. The optical window 56 is monolithic with said rim 55. This improves heat transfer even further, for example the heat conductive path 59.

1. An assembly of a holder device and an electronic module, wherein the holder device comprises an outer surface and a Zhaga slot;
wherein the Zhaga slot is recessed in said outer surface and is configured to mechanically connect the electronic module to the holder device;
wherein the electronic module comprises:
a main body comprising an electronics compartment;
an electronic component arranged in said electronics compartment;
a rim arranged in thermal communication with the electronic component and/or the electronics compartment;
wherein the rim is configured to abut the outer surface of the holder device when the electronic module is mechanically connected to the holder device;
wherein the rim is configured to transfer heat from the electronic component and/or electronics compartment into the ambient; P1 wherein the rim extends beyond the standardized boundaries demarcated for a Zhaga module suitable for the Zhaga slot.

2. The assembly according to claim 1, wherein the volume of the electronics compartment is at least a factor three smaller than the volume of the Zhaga slot.

3. The assembly according to claim 2, wherein the main body comprises a heat sink structure configured to transfer heat from the electronic component and/or the electronics compartment to the ambient;
wherein the heat sink structure is at least partly arranged outside the electronics compartment and within the volume of the Zhaga slot.

4. The assembly according to claim 3, wherein the heat sink structure comprises a heat sink and a heat conducting rod;
wherein the heat sink is arranged outside the electronics compartment;
wherein the heat conducting rod extends into the electronics compartment and connects the electronic component to the heat sink.

5. The assembly according to claim 1, wherein the electronic module comprises an optical window arranged on the main body;
wherein the optical window encloses at least part of the electronics compartment;
wherein the optical window enables an optical path between the electronic component and a space exterior to the holding device;
wherein the optical window is monolithic with said rim.

6. The assembly according to claim 1, wherein the holder device is a luminaire.

7. The assembly according to claim 1, wherein the electronic component comprises at least one sensor.

8. The assembly according to claim 1, wherein the electronic component comprises at least one wireless communication module.

9. The assembly according to claim 8, wherein the electronic component comprises a Li-Fi transceiver; or
wherein the electronic component comprises a mmWave radiofrequency transceiver.

10. The assembly according to claim 1, wherein the electronic component comprises at least one semiconductor light source.

11. The assembly according to claim 10, wherein the at least one semiconductor light source is configured to provide ultraviolet light having at least one dominant peak in a wavelength range from 280 to 315 nm (UVB).

12. The assembly according to claim 10, wherein the at least one semiconductor light source is configured to provide ultraviolet light having at least one dominant peak in a wavelength range from 100 to 280 nm (UVC).

13. The assembly according to claim 1, wherein the electronic component generates, in operation, at least 1.5 watt of thermal energy.

14. The assembly according to claim 1, wherein the main body comprises a heat conductive structure;
wherein the heat conductive structure is configured to connect the rim to the electronic component and/or the electronics compartment;
wherein at least part of the heat conductive structure is aligned along an exterior contour of the main body.

15. The assembly according to claim 1, wherein the main body comprises a housing, wherein said housing is made of a polymer material, wherein the rim is at least partly made of a metal material.
